(19) United States
(12) Patent Application Publication
(10) Pub. No.: US 2010/0089698 A1
(43) Pub. Date: Apr. 15, 2010

(54) PICKUP TRUCK TAILGATE LADDER

(76) Inventor: JEFFERY E. BRODSACK, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/251,017

(22) Filed: Oct. 14, 2008

(51) Int. Cl. E06C 5/20; B60R 3/02

(52) U.S. Cl. 182/127; 296/62; 280/163

(57) ABSTRACT

A folding ladder is provided for a pickup truck tailgate to assist a person getting into and out of the bed of the truck. The ladder includes a frame hooked to the tailgate, an upper ladder section pivotally connected to the frame, and a lower ladder section pivotally connected to the upper ladder section. The ladder is foldable between a storage position adjacent the tailgate and a use position extending downwardly from the tailgate. The ladder sections reside in a single plane when opened to the use position and nest adjacent the tailgate when in the folded storage position.

### BACKGROUND OF THE INVENTION

Pickup trucks often carry objects in the bed, which necessitates a person getting into and out of the bed to load and unload the objects. Such entry and exit of the person to and from the pickup truck bed is not always easy, depending upon the height of the bed, the physical abilities of the person, and the object being carried into and out of the bed. The prior art includes various ladder structures to assist the person in getting into and out of the bed. Such ladders are mounted or attached to the tailgate of the pickup truck in various manners. For example, some ladders are formed as part of the tailgate, and thus cannot be removed from the tailgate or retrofit onto existing tailgates. Other prior art tailgate ladders are bolted, welded or otherwise fixed to the inside of the tailgate and fold open for use. Many of these ladders require holes to be drilled into the tailgate for the mounting of bolts or screws. Such ladders require tools for installation of the ladder, and cannot be quickly and easily removed from the tailgate without the use of tools. Some prior art tailgate ladders are foldable through scissor-type action, which necessarily includes numerous components and pivot points, which increase manufacturing costs.

Therefore, a primary objective of the present invention is the provision of an improved ladder for a pickup truck tailgate for use by a person climbing into and out of the bed of the truck.

Another objective of the present invention is the provision of a pickup truck tailgate ladder which can be quickly and easily installed and removed from the tailgate.

A further objective of the present invention is the provision of a pickup truck tailgate ladder which mounts to the truck without the use of tools.

Still another objective of the present invention is the provision of a ladder for a pickup truck tailgate which can be installed without drilling holes in the tailgate.

A further objective of the present invention is the provision of a ladder for a pickup truck which can be mounted to the tailgate without the use of threaded fasteners.

Another objective of the present invention is the provision of a ladder for a pickup truck tailgate having three sections and two pivot axes.

Still another objective of the present invention is the provision of a ladder for a pickup truck which simply hooks to the tailgate for movement between storage and use positions.

Still another objective of the present invention is the provision of a ladder for a pickup truck tailgate having sections which fold without scissor action.

A further objective of the present invention is the provision of a pickup truck tailgate ladder having step sections residing in a single plane when the ladder is extended for use.

Another objective of the present invention is the provision of a tailgate ladder for a pickup truck which is economical to manufacture, and durable and safe in use.

These and other objectives will become apparent from the following description of the invention.

### BRIEF SUMMARY OF THE INVENTION

The pickup truck tailgate ladder of the present invention includes a frame having a pair of rails with opposite ends, and a hook on each end of each rail to hook the frame onto the tailgate without the use of threaded fasteners or tools. The ladder also includes upper and lower ladder sections each having one or more steps. The upper ladder section is pivotally connected to the frame for rotation up to 270° about a first axis. The lower ladder section is pivotally connected to the upper ladder section for rotation approximately 180°. The ladder sections can be folded from a storage position between the rails of the frame adjacent the tailgate and a use position extending downwardly from the tailgate so that a person can climb up and down the steps of the ladder sections. If desired, the ladder can be easily removed from the tailgate by disengaging the hooks, without the use of tools.

### BRIEF DESCRIPTION OF THE DRAWINGS

FIG. 1 is a perspective view of the pickup truck tailgate ladder of the present invention shown in a use position with the tailgate open and the ladder sections folded down.

FIG. 2 is a perspective view of the pickup truck tailgate ladder folded into a storage position, with the tailgate down.

FIG. 3 is a perspective view showing the ladder in a storage position, with the tailgate up.

FIG. 4 is a top plan view of the ladder in the use position, with the tailgate down.

FIG. 5 is an end view of the ladder in the storage position, with the tailgate down.

FIG. 6 is an end view of the ladder in the use position.

FIG. 7 is a perspective view of the ladder removed from the tailgate.

### DETAILED DESCRIPTION OF THE PREFERRED EMBODIMENT

The ladder of the present invention is generally designated by the reference numeral 10 in the drawings. The ladder 10 includes three sections, a frame 12, an upper ladder section 14, and a lower ladder section 16. The frame 12 includes a pair of spaced apart rails 18, with arms 20 interconnecting the rails 18 such that the frame 12 is rigid. The rails 18 have opposite upper and lower ends, with a hook 22 on each end of each rail 18. The hooks 22 are adapted to mount onto the upper and lower edges of the tailgate 24 so as to retain the frame 12 on the tailgate 24 without the use of other connection means, such as threaded fasteners, welding, or the like. Thus, the hooks 22 alone mount the frame 12 to the tailgate 24 and eliminate the need to provide holes in the tailgate 24 for screws or bolts.

The upper end of the upper ladder section 14 is pivotally connected to the rearward end of the rails 18 by a pair of pins 26. The upper end of the lower ladder section 16 is pivotally connected to the lower end of the upper ladder section 14 by a pair of pivot pins 28. Thus, the ladder 10 has only two pivot axes, defined by the pins 26 and 28. Each ladder section 14, 16 preferably has two steps 30, though more or less steps may be provided.

In the embodiment shown in the drawings, a separate leg 32 interconnects the upper end of the upper ladder section 14 with the rearward end of the frame rails 18. It is understood that the leg 32 can be integrally formed with the rails 18, rather than being a separate component. The lower end of the lower ladder section 16 may include anti-slip feet 34 for engaging the ground. In an alternative embodiment, the feet 34 may be pivotally attached to the lower ladder section 16.

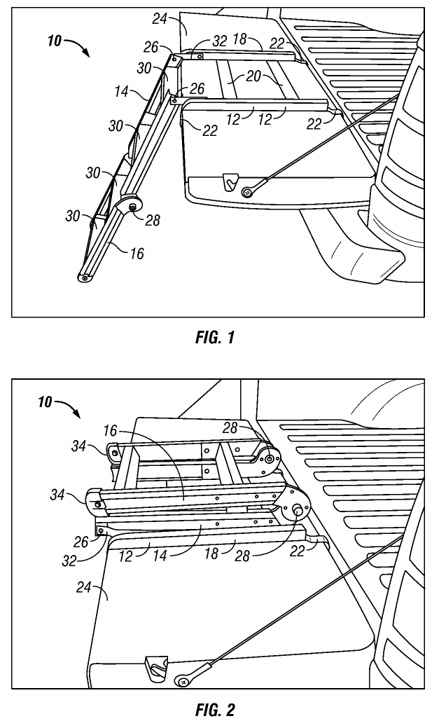

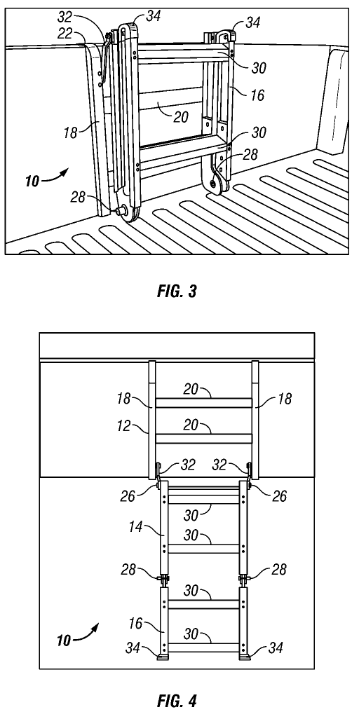

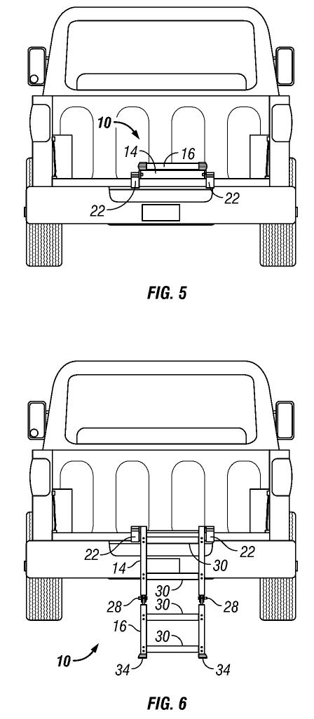

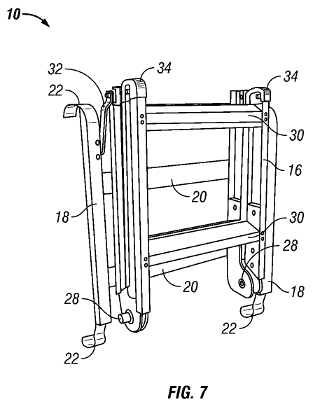

The ladder 10 is foldable between a use position shown in FIGS. 1, 4, 6, and 7 and a storage position shown in FIGS. 2, 3 and 5. In the use position, the upper and lower ladder sections 14, 16 reside in a single plane, with the sections being foldable approximately 180° relative to one another about the axis defined by the pivot pins 28. The pivotal connection between the upper and lower ladder sections 14, 16 limits the rotational movement between the sections to no more than 180°, so that the joint between the sections 14, 16 will remain rigid when the ladder 10 is in the use position. To move from the use position shown in FIG. 1 to the storage position shown in FIG. 2, the upper ladder section 14 pivots in a clockwise direction about the axis defined by the pivot pins 26 and the lower ladder section 16 rotates in a counterclockwise direction about the pivot pins 28 until the sections 14, 16 are nested within the frame 12, as shown in FIG. 2. In the storage position, the upper ladder section 14 is sandwiched between the frame 12 and the lower ladder section 16, as best seen in FIG. 2. To move from the storage position to the use position, the folding action of the ladder sections 14, 16 is reversed. Preferably, the ladder sections 14, 16 reside between the rails 18 of the frame 12 when folded into the storage position, as best seen in FIG. 5. Thus, the ladder 10 occupies minimal space adjacent the tailgate 24. The tailgate 24 can be moved from the open horizontal position, as shown in FIG. 2, to a closed vertical position, as shown in FIG. 3, with the ladder 10 remaining hooked on the tailgate 24.

The angle of the ladder sections 14, 16 relative to the tailgate will vary when the ladder is folded to the use position, depending upon the distance between the tailgate and the ground or roadway. At a maximum, the ladder sections 14, 16 will extend substantially vertically from the tailgate 24, approximately 270° from the frame 12, when the height of the tailgate 24 from the ground is equal to or greater than the length of the unfolded ladder sections 14, 16. As the height of the tailgate 24 above the ground decreases, the angle of the ladder sections 14, 16 extending rearwardly from the tailgate 24 will decrease.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A ladder for a pickup truck tailgate, comprising:
a pair of rails each having opposite forward and rearward ends with a hook on each end to hook onto lower and upper edges of the tailgate, respectively;
an upper ladder section having an upper end pivotally connected to the rearward ends of the rails so as to fold up to 270° relative to the rails and having at least one step; and
a lower ladder section having an upper end pivotally connected to the upper ladder section so as to fold approximately 180° relative to the upper ladder section and having at least one step;
whereby the ladder sections are foldable between a raised storage position adjacent the tailgate and an extended use position extending from the tailgate.

2. The ladder of claim 1 wherein the rails mount to the tailgate without tools.

3. The ladder of claim 1 wherein the rails mount to the tailgate without providing holes in the tailgate.

4. The ladder of claim 1 wherein the rails mount to the tailgate without threaded fasteners.

5. The ladder of claim 1 wherein the rails hooks alone removably secure the ladder to the tailgate.

6. The ladder of claim 1 wherein the ladder sections reside between the rails when folded to the storage position.

7. The ladder of claim 1 further comprising at least one arm extending between the rails.

8. The ladder of claim 1 wherein the rails are connected by a pair of arms.

9. The ladder of claim 1 wherein the pivotal connections between the upper rail section and the rails is adjacent the rearward end of the rails and above the upper edge of the tailgate.

10. The ladder of claim 1 wherein the ladder sections fold without scissor action.

11. A pickup truck tailgate ladder for use on a tailgate pivotal between a vertical raised position and a horizontal lowered position, the ladder comprising:
upper and lower ladder sections pivotally joined end to end;
at least one step on each ladder section
a frame hooked on the tailgate; and
a pivotal connection between the frame and the upper ladder section;
whereby the ladder sections are pivotal between a storage position adjacent the frame and tailgate, and a use position extending downwardly from the tailgate when the tailgate is in the lowered position; and
the upper and lower sections being coplanar when in the use position.

12. The pickup truck tailgate ladder of claim 11 wherein the upper and lower ladder sections pivot approximately 180° relative to one another between the storage and use positions.

13. The pickup truck tailgate ladder of claim 11 wherein the upper ladder section pivots more than 180° relative to the frame between the storage and use positions.

14. The pickup truck tailgate ladder of claim 11 wherein the frame mounts to the tailgate without the use of tools.

15. The pickup truck tailgate ladder of claim 11 wherein the frame has a fixed length with hooks at opposite ends for mounting to the tailgate.

16. The pickup truck tailgate ladder of claim 11 wherein the frame is free from threaded fasteners.

17. The pickup truck tailgate ladder of claim 11 wherein the frame has opposite ends with hooks at each end, the hooks alone securing the frame to the tailgate.

18. The pickup truck tailgate ladder of claim 11 wherein the ladder sections pivot without scissor action.

19. The pickup truck tailgate ladder of claim 11 wherein each ladder section has opposite sides with two steps extending between the sides.

20. The pickup truck tailgate ladder of claim 11 wherein the ladder sections and frame define only two pivot axes for movement between the storage and use positions.
